(19) United States
(12) Patent Application Publication
(10) Pub. No.: US 2021/0165426 A1
(43) Pub. Date: Jun. 3, 2021

(54) METHOD AND APPARATUS FOR DETERMINING AERIAL ROUTES BASED ON MAPPING DRONE DISABLING INSTRUMENTS

(71) Applicant: HERE Global B.V., Eindhoven (NL)

(72) Inventor: Donta WHITE, Racine, WI (US)

(21) Appl. No.: 16/700,699

(22) Filed: Dec. 2, 2019

(51) Int. Cl. G05D 1/10; G06F 16/901; B64C 39/02; G01C 21/00

(52) U.S. Cl. CPC G05D 1/106; G06F 16/9024; B64C 39/024; B64C 2201/141; B64C 2201/027; B64C 2201/128; G01C 21/005

(57) ABSTRACT

An approach is provided for mapping drone-disabling instruments and generating aerial routes. The approach, for example, involves receiving map data indicating a spatial concentration of a drone-disabling instrument over a geographic area. The spatial concentration can be based on real-time data, historical data, or a combination thereof. The approach also involves generating a map data layer of a geographic database based on the spatial concentration. The approach further involves providing the map data layer as an output.

### BACKGROUND

As aerial drone delivery becomes an increasingly common way to deliver packages, ensuring that a package arrives at its destination will become a big issue within the fulfillment processes. For example, the growing use of unmanned aerial drones for commercial services makes drones attractive targets for attack or interception by any number of manmade or natural drone-disabling instruments (e.g., projectiles, predatory birds, etc.). As result, drone operators and related service providers face significant technical challenges to minimize the risk of loss from such attacks or interceptions.

### SOME EXAMPLE EMBODIMENTS

Therefore, there is a need for an approach for mapping the concentrations of drone-disabling instruments, modeling the range of drone-disabling instruments, and routing aerial drones or vehicles accordingly (e.g., so that aerial vehicles can avoid such drone-disabling instruments to reduce safety risks as they plan their routes).

According to one embodiment, a method comprises receiving map data indicating a spatial concentration of a drone-disabling instrument (e.g., guns, slingshots, etc.) over a geographic area. In one embodiment, the spatial concentration is based on real-time data, historical data, or a combination thereof. The method also comprises generating a map data layer of a geographic database based on the spatial concentration. The method further comprises providing the map data layer as an output.

According to another embodiment, an apparatus comprises at least one processor, and at least one memory including computer program code for one or more computer programs, the at least one memory and the computer program code configured to, with the at least one processor, cause, at least in part, the apparatus to receive map data indicating a spatial concentration of a drone-disabling instrument over a geographic area. In one embodiment, the spatial concentration is based on real-time data, historical data, or a combination thereof. The apparatus is also caused to generate a map data layer of a geographic database based on the spatial concentration. The apparatus is further caused to provide the map data layer as an output.

According to another embodiment, a computer-readable storage medium carries one or more sequences of one or more instructions which, when executed by one or more processors, cause, at least in part, an apparatus to receive map data indicating a spatial concentration of a drone-disabling instrument over a geographic area. In one embodiment, the spatial concentration is based on real-time data, historical data, or a combination thereof. The apparatus is also caused to generate a map data layer of a geographic database based on the spatial concentration. The apparatus is further caused to provide the map data layer as an output.

According to another embodiment, an apparatus comprises means for receiving map data indicating a spatial concentration of a drone-disabling instrument over a geographic area. In one embodiment, the spatial concentration is based on real-time data, historical data, or a combination thereof. The apparatus also comprises means for generating a map data layer of a geographic database based on the spatial concentration. The apparatus further comprises means for providing the map data layer as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of mapping drone-disabling instruments and generating aerial routes, according to one embodiment;

FIG. 2 is a diagram of the components of a mapping platform, according to one embodiment;

FIG. 3 is a flowchart of a process for mapping drone-disabling instruments and generating aerial routes, according to one embodiment;

FIG. 4A is a diagram illustrating an example drone-disabling risk zone, according to one embodiment;

FIG. 4B is a diagram of a user interface illustrating spatial concentrations of drone-disabling instruments, according to one embodiment;

FIG. 4C is a diagram illustrating an example drone-disabling instrument risk data model, according to one embodiment;

FIG. 5 is a diagram of a geographic database capable of storing map data for drone routing, according to one embodiment;

FIG. 6 is a diagram of hardware that can be used to implement an embodiment;

FIG. 7 is a diagram of a chip set that can be used to implement an embodiment; and

FIG. 8 is a diagram of a mobile terminal (e.g., handset or aerial vehicle or part thereof) that can be used to implement an embodiment.

### DESCRIPTION OF SOME EMBODIMENTS

Examples of a method, apparatus, and computer program for determining aerial routes based on mapping drone-disabling instruments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

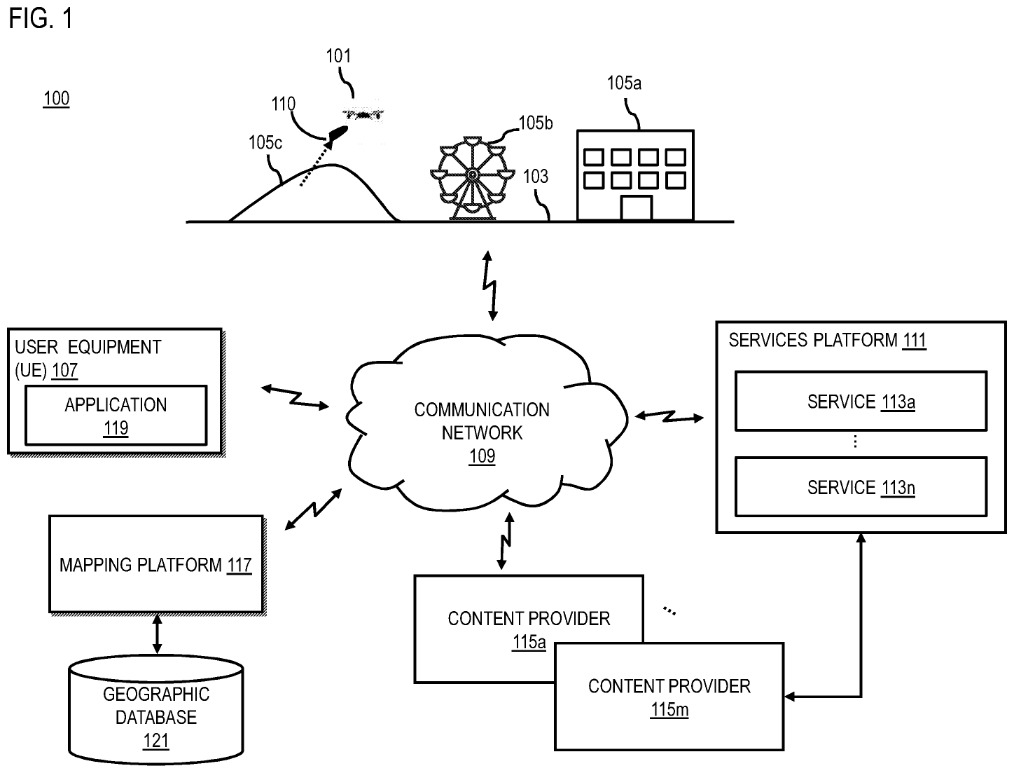

FIG. 1 is a diagram of a system 100 capable of mapping drone-disabling instruments and generating aerial routes, according to one embodiment. The use of unmanned aerial vehicles is becoming more widespread particularly for commercial services such as package delivery. Commercial uses generally requirement high target of levels of successful trips (e.g., successfully reaching a delivery location or other destination with cargo intact). However, as drone delivery services become more common, these services may also face growing risks from attacks arising from drone piracy, vandalism, accidents, etc. from various drone-disabling instruments encountered along their routes. As used herein, the term drone-disabling instrument refers to any manmade or natural instrument that is capable of attacking, intercepting, disabling, etc. a manned or unmanned aerial vehicle 101. An unmanned aerial vehicle (UAV) is commonly known as a drone. Therefore, service providers face significant technical challenges to optimize drone routing to ensure successful trip completion in light of threats to the drone or aerial vehicle 101 posed by drone-disabling instruments.

Generally, an aerial vehicle 101 operates by flying above the ground 103, buildings 105a, playgrounds 105b, hills 105c, etc. (also collectively referred to as terrain 105), and/or other public spaces where safety risks to the public and/or the aerial vehicle 101 as well as other flight restrictions often apply. In one embodiment, the terrain 105 includes geographic terrain that is the lay of the land expressed in terms of the elevation, slope, and orientation of terrain features. In another embodiment, the terrain 105 includes civilization terrain that includes manmade structures over the lay of the land expressed in terms of the elevation, slope, and orientation of terrain features.

By way of example, a human standing over buildings 105a, playgrounds 105b, hills 105c, etc. may aim a drone-disabling instrument (e.g., a slingshot, a gun, etc.) to project an object 110 at the aerial vehicle 101 that could affect or damage the aerial vehicle 101's or its ability to operate safely. In addition, any crashing or malfunctioning of the aerial vehicle 101 can pose serious threat to a package carried by the aerial vehicle 101. Other issues occurring in specific areas of the flight path or potential flight path of the aerial vehicle 101, such as events (e.g., protests, festivals, etc.) where the probability of encountering drone-disabling instruments (e.g., fireworks, etc.) can also increase potential risks associated with operating the aerial vehicle 101. For example, flying over areas with high densities of drone-disabling instruments can increase the probability that the aerial vehicle 101 may encounter or be attacked with a drone-disabling instrument. While pilots (e.g., human or machine) of aerial vehicles 101 can typically see potential physical obstacles (e.g., buildings or structures that can increase collision risks) and avoid them, it can be much more technically challenging for pilots to determine or perceive risks such as flying over drone-disabling instrument populated areas that may also significantly increase safety risks. As mentioned above, drone-disability instruments can also be natural instruments (e.g., non-made or naturally occurring instruments such as but not limited to animals who may attack or disable a drone or aerial vehicle 101). For example, similar safety risks may be encountered by flying through animal habitats (e.g., eagle nesting areas) with animals (e.g., large birds) that can attack the aerial vehicle 101.

To address the technical challenges, the system 100 of FIG. 1 introduces a capability to map the densities of drone-disabling instruments occurring over a geographic area, and then to use the mapped data do create a route over the geographic that is optimized based on the densities of the drone-disabling instruments (e.g., by using a routing cost function that avoids areas with densities of drone-disabling instruments above a threshold density). In one embodiment, the system 100 can also configure an aerial vehicle 101 or drone to react in real-time and/or to re-route based on the mapped historical and real-time data and intelligence on drone-disabling instruments. In this way, the system 100 can combine optimized drone routes with real-time edge decision making at critical decision points to ensure the success of a drone route (e.g., success of a package delivery mission).

Although the various embodiments described herein are discussed with respect to drones or aerial vehicles 101 operating in the airspace above the ground, it is contemplated that the embodiments are applicable to any type of vehicle (manned or unmanned) operating on the surface of the Earth. Accordingly, any use of the term drone-disabling instrument is intended to include or be used synonymously with vehicle-disable instruments (e.g., any instrument capable of attacking, disabling, etc. a vehicle as it travels) in general. In addition, the terms drones or aerial vehicles 101 is intended to be used synonymously with vehicles in general including but not limited to surface or ground vehicles (e.g., cars, trucks, trains, ships, etc.).

In one embodiment, to map the spatial densities of drone-disabling instruments, the system 100 can factor the historical and real-time probe data (e.g., from other aerial vehicles 101 or drones), sensor data, and/or other available data on ownership and/or use of drone-disabling instruments in a given geographic area. For example, one type of drone-disabling instrument is a gun. In this example, the system 100 can queried data indicating gun ownership and/or the number concealed carry permits in a given area or geometry. In one embodiment, the system 100 can combine the queried data with other data such as but not limited to crime data and reports involving use of drone-disabling instruments, sales data on drone-disabling instruments, land usage involving the drone-disabling instruments (e.g., land used for hunting), etc. to generate map data indicating the historical and/or real-time densities of drone-disabling instruments in a given geographic area for storage in a geographic database 121.

The map data in the geographic database 121 can then be used to predict an on-coming potential encounter between a drone and a drone-disabling instrument, or to generate drone routes that avoids or minimizes potential exposure to drone-disabling instruments. In this way, the system 100 advantageously enables drone operators to navigate their drones or aerial vehicles 101 with reduced risks or with a greater understanding of the risks arising from encountering drone-disabling instruments on a route.

In summary, the data used by the system 100 to map drone-disabling instruments and/or route/re-route/react/etc. to drone-disabling instruments include but is not limited to:
Available real-time and historical data of permits for drone-disabling instruments (e.g., concealed carry permit holders of guns);
Available real-time and historical data of crime data involving use of a drone-disabling instrument in an area within or along a route a drone may take (e.g., to deliver a package);
Available real-time and historical data on weather in a certain area;
Available real-time and historical data on sales of drone-disabling instruments (e.g., guns, slingshots, bows and arrows, lasers, etc.) in a given area;
Available real-time and historical data involving drone robberies and/or attempted robberies;
Available real-time and historical data on events that may involve use of drone-disabling instruments (e.g., 21-gun salutes at funerals, firework use at 4^{th} of July Celebration, sporting events such as biathlons, etc.); and
Available real-time and historical data on events that may become violent (e.g., violent protest, demonstrations, etc.).

In one embodiment, the system 100 enables human and machine pilots or other operators of aerial vehicles 101 to calculate the safety risks associated with a given geographic by determining location-based risk factors resulting from drone-disabling instruments. To calculate these risk factors, the system 100 can model the effective range of different types of drone disabling instruments. The effective range, for instance, indicates the distance at which the drone-disabling instrument can disable or interfere with the operation of a drone. This data model of the effective range can then be combined with terrain data and the drone-disabling instrument density data to identify locations where drones may likely encounter a drone-disabling instrument.

For instance, in an example scenario, data for a given geographic location indicates that there is a high concentration of slingshots in a given area (e.g., based on sales data in the area indicating more than a threshold number of slingshots sold). The system 100 has modeled the effective range of the slingshot at 20 meters from a shooting location. The system 100 further determines that there is a hill 20 meters high in the area. Thus the system 100 may determine that a drone flying at 40 meters over the hill may still be within the effective range of the slingshot and subject to potential attack.

In one embodiment, the system 100 can then represent or visualize the calculated risks as a “risk data layer” of the geographic database 121 for the geographic area where the aerial vehicles 101 will fly over. In one embodiment, the visual representation or “risk data layer” highlights or otherwise indicates the risk for the aerial vehicle 101 to operate over the area represented by the risk data layer, such as a spatial concentration or density of one or more drone-disabling instruments. In other embodiments, the risk data layer is a combination of risks composed of one or more other risk factors (e.g., visible or invisible) associated with the geographic area including but not limited to a wind speed, visibility, weather, etc. in combination with the risks from the drone-disabling instruments.

On example representation of the “risk data layer” is a drone-disabling instrument density and/or volume spreading over an area of interest. When rendered on or near a corresponding location (e.g., a building 105a, a playground 105b, a hill 105c, etc.), the density/volume can appear as a “disabling probability column” rising from the location, so that the aerial vehicle 101 or its operator can visualize the risks from drone-disabling instruments a “virtual object” to avoid in a similar manner to other physical obstacles (e.g., buildings), in one embodiment. In another embodiment, the density/volume can appear as a “disabling probability heat map” on the ground.

As indicated above, the extent of the density/volume and/or effective range of vehicle-disabling instruments represents the aggregated risk for a given location in the geographic area. For the example, the height and/or any other dimension of the visual representation of the risk data layer can be scaled to be proportional to the calculated risk level for the area. In one embodiment, the height of the risk data layer is a function of time and hence creates a user interface with a dynamic landscape of multiple risk data layers that go “up and down” over the course of the day or other period of time to reflect the frequently changing patterns of the risk function aggregating risk factors for an area of interest such as but not limited to vehicle-disabling instrument density and/or any other risk parameters that can affect the safety of operating the aerial vehicle 101.

In one embodiment, the system 100 also includes a capability to dynamically predict vehicle-disabling instrument density data (e.g., in real-time) for a given area based on collecting data from various data sources of human activity in the area, and then using the data to make the predictions of vehicle-disabling instrument density. In one embodiment, dynamic prediction of vehicle-disabling instrument density refers to predicting or estimating the human population density for an area that can differentiate based on dynamic factors such as but not limited to time (e.g., estimate population density with respect to days, weeks, time of day, seasonality) and expected future events (e.g., sporting events, concerts, festivals, etc.). The embodiments of dynamic vehicle-disabling instrument density described herein enables dynamic modeling of vehicle-disabling instrument flows in an area of interest so that vehicle-disabling instrument density can be determined or predicted with greater temporal granularity. By analogy, dynamic prediction of vehicle-disabling instrument density refers to predicting or estimating the animal population density (e.g., birds, monkeys, etc.) for an area that can differentiate based on dynamic factors such as but not limited to time (e.g., estimate population density with respect to days, weeks, time of day, seasonality) and expected future events (e.g., animal migration, etc.).

In one embodiment, with respect to an aerial vehicle use case, the dynamic vehicle-disabling instrument density data along with other risk factors can be used to predict the risk levels of areas wherein the aerial vehicle 101 will fly over. In other words, the system 100 enables the capability to quantify the risk levels that the aerial vehicle 101 may meet on the way by generating a risk data layer or a risk data model of the aggregated risks of areas at a time when the aerial vehicle 101 is predicted to fly over the areas. In one embodiment, the system 100 can then route the aerial vehicle 101 to avoid areas with risk levels above a threshold value or determine a route along which the aerial vehicle 101 is expected to fly over a minimum level of risk. In this way, safety risks can be reduced by reducing possible casualties or other risk factors that can result in case of a damage or crash of the air vehicle 101.

Other risk factors (e.g., visible or invisible) associated with the geographic area may include but not limit to:
Location data associated with presence of drone-disabling instruments;
Event data associated with presence of drone-disabling instruments;
Incident and crime data involving unmanned vehicles;
Electromagnetic fields;
Absence of GPS or other location signals;
Winds or other weather conditions;
Network (e.g., cellular network) coverage; and
Aviation-related data (e.g., air traffic, etc.).

It is noted that the aerial vehicle use case is one example application of dynamic vehicle-disabling instrument density data, it is contemplated that the embodiments of dynamic vehicle-disabling instrument density data described herein can be for any application including but not limited to autonomous vehicles, fleet vehicles, (e.g., delivery vehicles), emergency vehicles, shared vehicle, private vehicles, etc.

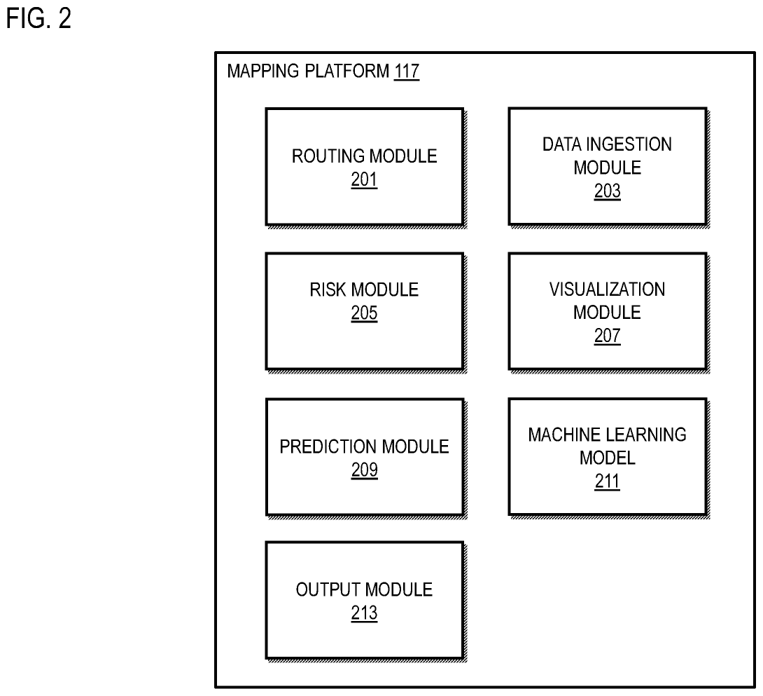

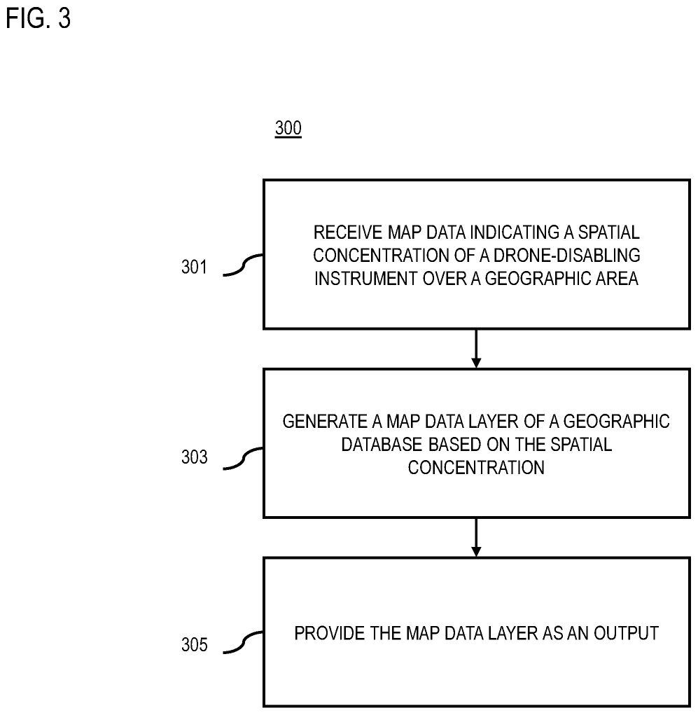

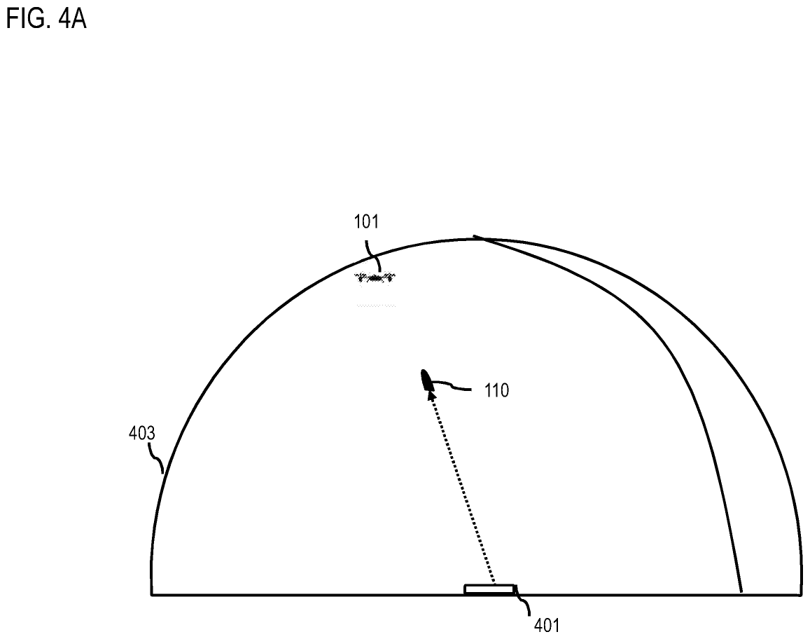

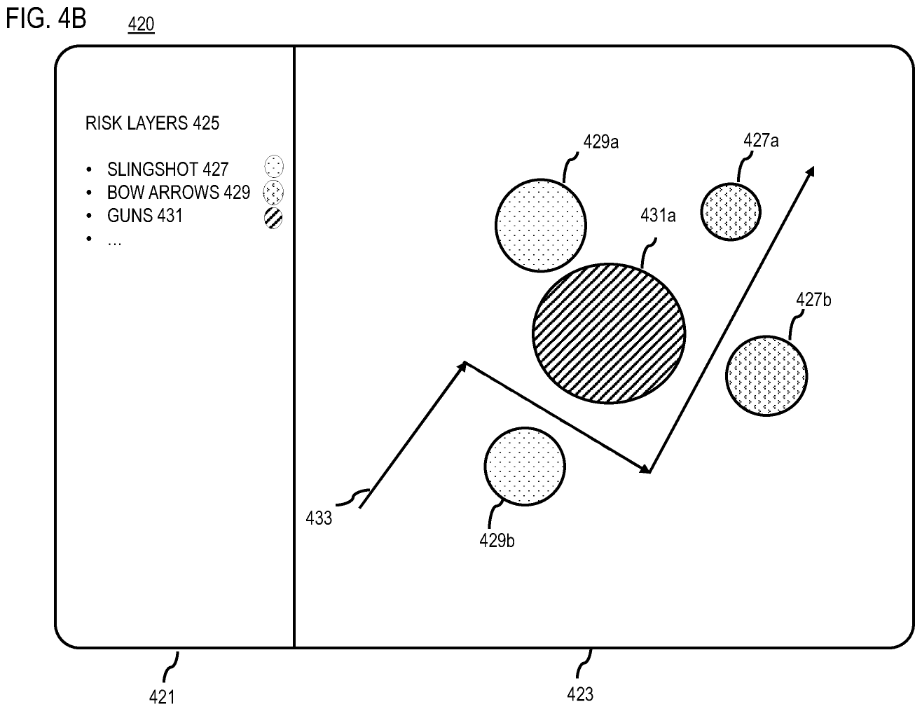

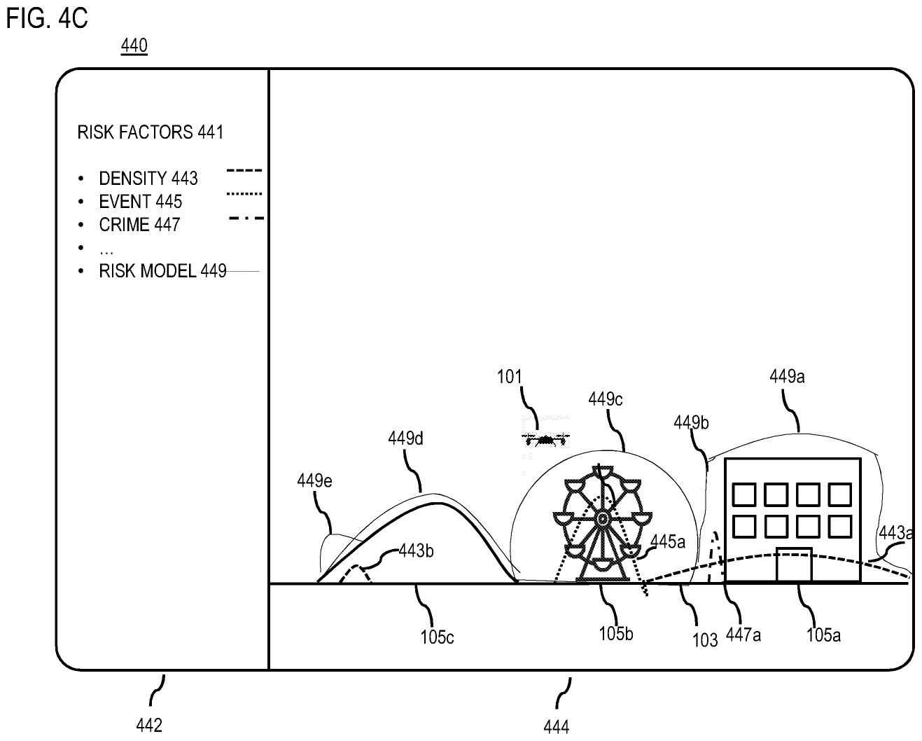

In one embodiment, the mapping platform 117 includes one or more components for providing dynamic population density modeling according to the various embodiments described herein. As shown in FIG. 2, the mapping platform 117 includes a routing module 201, a data ingestion module 203, a risk module 205, a visualization module 207, a prediction module 209, a machine learning model 211, and an output module 213. The above presented modules and components of the mapping platform 117 can be implemented in hardware, firmware, software, or a combination thereof. It is contemplated that the functions of these components may be combined or performed by other components of equivalent functionality. Though depicted as a separate entity in FIG. 1, it is contemplated that the mapping platform 117 may be implemented as a module of any of the components of the system 100 (e.g., a component of the aerial vehicle 101 and/or a client device such UE 107). In another embodiment, the mapping platform 117 and/or one or more of the modules 201-213 may be implemented as a cloud-based service, local service, native application, or combination thereof. The functions of these modules are discussed with respect to FIGS. 3-4 below.

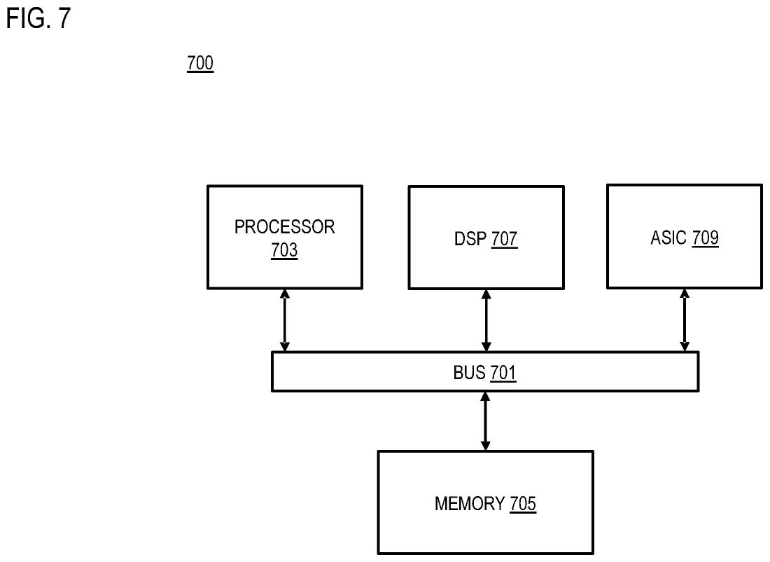

FIG. 3 is a flowchart of a process for mapping drone-disabling instruments and generating aerial routes, according to one embodiment. In various embodiments, the mapping platform 117, any of the modules 201-213 of the mapping platform 117, and/or a local component of the aerial drone 101 may perform one or more portions of the process 300 and may be implemented in, for instance, a chip set including a processor and a memory as shown in FIG. 7. As such, the mapping platform 117, any of the modules 201-213 of the mapping platform 117, and/or the local component of the aerial drone 101 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all of the illustrated steps.

In step 301, the risk module 205 receives map data indicating a spatial concentration of a drone-disabling instrument over a geographic area. In one embodiment, the data ingestion module 203 retrieves real-time data, historical data, or a combination thereof indicating the spatial concentration of the drone-disabling instrument, and calculates the spatial concentration based on the real-time data, the historical data, or a combination thereof.

In one embodiment, the risk module 205 determines the spatial concentration based on ownership data indicating a number of owners of the drone-disabling instrument in the geographic area. In other embodiments, the data ingestion module 203 retrieves other risk factor data for the risk module 205 to determine the spatial concentration.

In one embodiment, the data ingestion module 203 can sense, determine, retrieve, and/or query a geographic database 121 or equivalent for the any of the risk factor data. For example, the spatial concentration of a drone-disabling instrument density data can be calculated by the risk module 205 according to risk factor data that can result in increased risks of casualties if the aerial vehicle 101 crashes in the area during a flight. By way of example, the risk factor data includes crime data indicating a number of crimes committed using the drone-disabling instrument in the geographic area. In one embodiment, the risk factor data includes sales data indicating a number of sales of the drone-disabling instrument (e.g., slingshot, bow arrows, guns, etc.) and address data of the registered owners in the geographic area. In another embodiment, the data ingestion module 203 retrieves 3D-printed guns website cookies data to determine a spatial concentration of 3D-printed guns in a geographic area.

In another embodiment, the risk factor data includes event/location data indicating a presence of or a number of events and/or event locations in which the drone-disabling instrument is used in the geographic area. By way of examples, such events and event locations include professional/collegiate/interscholastic football, baseball, soccer, lacrosse, basketball/tennis/volleyball courts/fields, Olympics competitions, outdoor shooting ranges, elementary/middle/high school playground areas, discus/frisbees/boomerangs fields in neighborhood parks, archery parks, ski jumping hills, sledding hills, golf courses and driving ranges, blimps/hot air balloons festivals, helicopter ride lunching areas, etc. In one embodiment, the data ingestion module 203 retrieves land usage data to determine golf courses and driving ranges, hunting grounds for duck, deer), etc.

The effective range of a drone-disabling instrument represented by a risk zone. For example, the risk zone can be defined as a dome or any other shape (e.g., rectilinear polygon, dome, Voronoi shape, etc.) forming a location of the drone-disabling instrument. FIG. 4A is a diagram illustrating an example drone-disabling risk zone, according to one embodiment. In one embodiment, the size of the dome or shape (e.g., the extent of the risk zone 403 represented by or corresponding to the shape) can be based on the firing power of the drone-disabling instrument 401 (e.g., a slingshot projects an object 110 at the aerial vehicle 101).

In step 303, the prediction module 209 generates a map data layer of a geographic database based on the spatial concentration of the drone-disabling instrument (e.g., slingshots). In one embodiment, the size of the dome or shape (e.g., the extent) of a risk zone is represented by or corresponding to a drone-disabling instrument density and/or volume spreading in a risk zone.

FIG. 4B is a diagram of a user interface illustrating spatial concentrations of drone-disabling instruments, according to one embodiment. In FIG. 4B, the user interface (UI) 420 includes a first element 421 for presenting information on different risk layers and a second element 423 for presenting spatial concentrations of different drone-disabling instruments. For example, the first element 421 lists different risk data layers 425 for different drone-disabling instruments, such as slingshots 427, bow arrows 429, guns 431, etc. FIG. 4B shows two slingshot cycles/zones 427a and 427b, two bow arrow cycles/zones 429a and 429b, and one gun cycle/zone 431a on the UI 420.

By way of example, given thresholds on confidence levels and/or number of registrations and/or observations of a drone-disabling instrument in risk zones in the geographic area, the risk module 205 determines a pattern of the cycles that reflect the drone-disabling instrument density and/or volume spreading in respective risk zones, while the size of the cycle or other shape reflects effective ranges of the respective type of drone-disabling instrument (e.g., slingshots) depending on its firing power. In one embodiment (e.g., FIG. 4B), the visualization module 207 generates a representation of the risk zones of all types of drone-disabling instruments. In another embodiment, the visualization module 207 generates a representation of the risk zones as a risk data layer per type of drone-disabling instrument.

In one embodiment, the visualization module 207 can use a trained machine learning model 211 or equivalent to predict a risk level for a given zone based on the aggregated risk factors of the area. For example, the trained machine learning model 211 can be trained using aggregated ground truth risk-related data that has been labeled or annotated with a known or ground-truth risk level. The risk factors aggregated from the geographic area can be used as input features to the trained machine learning model 211 to output a risk level prediction and optionally a corresponding confidence level of the prediction.

Ideally, for trip planning, a pilot/controller would pick a route which has no risk volume or risk data layer on the flight path (e.g., no crossing of any rendered risk zone). By way of example, the flight path 433 can be drawn or computed to avoid passing through any 3D risk zones of one or more of the risk data layers, to minimize safety risks over the flight path 433. In one embodiment, a risk zone is avoided horizontally by flying around on the same plane. In another embodiment, a risk zone is avoided vertically by flying at a different altitude/height. The routing module 201 can determine a required altitude change based on the data model representing the effective range of the drone-disabling instrument in combination with terrain data for the geographic area. In one embodiment, the routing module 201 retrieves a ground elevation or equivalent terrain data of a location that the aerial vehicle 101 is to fly over or to approach within a distance threshold. This ground elevation or terrain data can be retrieved from, for instance, the geographic database 121 or other equivalent data store providing ground elevation data. The routing module 201 can then interact with the prediction module 209 to predict the type of drone-disabling instrument (e.g., a weapon) that may be encountered at or within a distance threshold of the location according to the embodiments described herein. Based on the prediction, the risk module 205 determines a shooting range of the predicted drone-disabling instrument (e.g., 50 feet for a slingshot) or an effective range that drone disabling instrument can be projected. By way of example, the effective range refers to a distance over which use of the drone-disabling instrument can disable or cause damage to the aerial vehicle 101. Using the ground elevation data and determined range of the disabling instrument, the routing module 201 can determine an altitude or altitude change (e.g., how much higher the drone has to fly on a route relative to a route on which no drone-disabling instrument is expected or predicted) to generate on a route over the location. For example, if a location has a ground elevation of 100 feet above sea level and the mapping platform 117 predicts that slingshot capable of disabling a drone with a range of 50 feet is expected at the location, the mapping platform 117 can generate a route that takes an aerial drone 101 at least 150 feet (e.g., ground elevation plus range of drone disabling instrument) to avoid being within range of the drone disabling instrument. In one embodiment, the routing module 201 can add a safety margin to the recommended altitude, for instance, by applying a multiplicative factor to the range of drone disability instrument (e.g., a factor of 1.5 times so that in the example above the altitude would be 175 ft based on a ground elevation of 100 feet plus 1.5×the 50 feet range of drone disabling instrument).

In another embodiment, if the location includes a structure (e.g., a building, radio antenna, etc.) or other map feature (e.g., tree, pole, etc.), that can be accessed to increase the height of the drone-disabling instrument over the ground elevation, the routing module 201 can further consider the height of the structure or map feature when determining an altitude or vertical adjustment to avoid exposure to any potential drone-disabling instrument. In one embodiment, the routing module 201 can retrieve a height of the building 105a or other structure/map feature from the geographic database 121. The height of the structure and/or map feature can then be considered when determining how high the aerial vehicle 101 should fly over the location to avoid the drone disabling instrument. For example, the mapping platform 117 determines that a location has a ground elevation of 100 and has a building with roof access at 30 feet. As in the example above, the mapping platform 117 also predicts that there is a probability above a threshold probability of encountering a slingshot with a range of 50 feet at the location. Accordingly, the mapping platform 117 can generate a route that includes the aerial vehicle 101 flying at least 180 feet above the location (e.g., ground elevation plus building rooftop height plus range of the drone disabling instrument).

If a risk zone cannot be avoided, the pilot/controller could then take the route with the lowest risk (e.g., crossing objects with lower risk levels). This is especially useful when the pilot/controller needs to adapt to changing conditions while flying (e.g., during rerouting of a flight path) as the pilot will need to make very quick decisions on-the-fly.

In one embodiment, the mapping platform 117 uses ability of a computer program (or software) or a neural network (artificial intelligence) of the aerial vehicles 101 to create an optimal delivery route, react in real-time and/or reroute (or recreate route) the aerial vehicles 101 based on historical and real-time data and intelligence combined with real-time edge decision (such as split-decision, decision-point, cloud-decision) making at critical decision points for ensuring success of deliveries.

FIG. 4C is a diagram illustrating an example drone-disabling instrument risk data model, according to one embodiment. In one embodiment, the visualization module 207 generates the representation of a drone-disabling instrument risk data model that considers a vertical 3D risk zone of a drone-disabling instrument extending over a height of a 3D object (e.g., a building 105a, a playground 105b, a hill 105c, etc.).

In FIG. 4C, the UI 440 includes a first element 442 for presenting information on different risk factors and a second element 444 for presenting a risk data model. For example, the first element 442 lists different risk factors 441, such as densities/volumes of drone-disabling instruments 443, event data associated with presence of drone-disabling instruments 445, incident and crime data involving unmanned vehicles 447, etc. For example, the height of the risk data layer of one type of drone-disabling instrument can be proportional to the drone-disabling instrument density/volume and/or its effective range. FIG. 4C shows a density/volume distribution 443a of drone-disabling instruments with respect to the building 105a, a density/volume distribution 443b of the drone-disabling instruments with respect to the hill 105c, an event distribution 445a with respect to the playground 105b, and a crime distribution 447a with respect to the building 105a on the UI 440.

In FIG. 4C, the mapping platform 117 aggregates and presents the distributions of different risk factors over the respective terrains as a risk model 449, for a time associated with the aerial vehicle 101 to pass the geographic area. For example, the risk model 449 includes a building zone 449a, a crime zone 449b (on the left side of the building 105a), a playground zone 449c, a hill zone 449d, and a hillside zone 449e (on the left side of the hill 105c). In this example, the hill zone 449d covering the whole hill 105c has an higher elevation and risk, while the hillside zone 449e has even higher risk due to a higher concentrations of drone-disabling instruments, such as children playground on the hill side. The aerial vehicle 101 can avoid the risk data model 449 in a similar manner to physical obstacles (e.g., buildings). As mentioned, a risk data model is a three-dimensional (3D) that considers the terrain data vertically from the ground at the corresponding zone into the airspace above that is within effective ranges of the vehicle-disabling instruments.

In this embodiment, the visualization module 207 merges effective ranges (e.g., domes) of the vehicle-disabling instruments on tops of the real-world structures into the risk data model 449. By way of example, a dome may be on the top of the building 405a, on the side of the building 105a (e.g., a window), etc., where a vehicle-disabling instrument may fire at the aerial vehicle 101.

In one embodiment, the prediction module 209 creates a data model representing an effective range of the drone-disabling instrument. In one instance, the map data layer further includes the data model. In another instance, the data model includes the map data layer.

In step 305, the routing module 201 provides the map data layer as an output. By way of example, the routing module 201 routes an aerial drone over the geographic area based on the map data layer. The route can be determined using any routing engine known in the art based on an origin and destination specified by a pilot/controller of the aerial vehicle 101 for the route at a given time (e.g., expected start time of the route). In one embodiment, the aerial drone is a delivery drone, and wherein the drone-disabling instrument is configured to intercept the delivery drone, a payload of the delivery drone, or a combination thereof.

Ideally, for route planning, a pilot/controller would pick a route which does not cross any risk zone. If that is not possible, the pilot could then take the route with the lowest risk (e.g., crossing objects with lower risk levels). This is especially useful when the pilot/controller needs to adapt to changing conditions while flying (e.g., during rerouting of a flight path) as the pilot will need to make very quick decisions on-the-fly.

In one embodiment, the routing module 201 determines a route over the geographic area based on the data model representing the effective range of the drone-disabling instrument in combination with terrain data for the geographic area. The spatial concentration may include real-time spatial concentration data, and the routing module 201 calculates a real-time routing instruction based on the real-time spatial concentration data. In another embodiment, the real-time routing instruction is calculated by a local component of the aerial drone for real-time use by the aerial drone.

In one embodiment, the route is calculated using a cost function based on minimizing a probability of the aerial drone encountering the drone-disabling instrument over the geographic area. By way of example, the probability considers the spatial concentration of the drone-disabling instrument, the terrain data for the geographic area, other risk factors as discussed, etc.

In one embodiment, the data model further indicates a predicted damage level to the aerial drone, a payload of the drone, or a combination thereof that is calculated to be inflicted by the drone-disabling instrument, and the routing is further based on the predicted damage level.

In one embodiment, the prediction module 209 or the local component of the aerial drone calculates a probability of encountering the drone-disabling instrument based on the map data, and the routing module 201 initiates an activation of at least one sensor of the aerial drone. For instance, the at least one sensor is configured to collect sensor data for determining a presence of the drone-disabling instrument, such as acoustic sensors listening for drone-disabling instruments, cameras spotting the drone-disabling instruments, etc. In one embodiment, the sensor data is used to update the map data indicating the spatial concentration of the drone-disabling instrument, such as one or more lidar sensors detecting materials of the drone-disabling instruments, etc. By way of example, the materials can be used to identify the types and models of the drone-disabling instruments, to determine damage impacts in case of direct collision in the air, etc.

In another embodiment, based on the probability of encountering the drone-disabling instrument, the routing module 201 or the local component of the aerial drone initiates an evasive maneuver by the aerial drone based on determining that probability is greater than a threshold probability. By way of example, the aerial drone flies above, around, or below the one or more risk zones in the data model. In another example, the aerial drone flies via the one or more risk zones faster than a threshold reachable by the drone-disabling instrument. In yet another example, the aerial drone flies via the one or more risk zones in a pattern, in or near a shelter, or a combination thereof, to dodge one or more of the aerial vehicle attacking objects mapped in the one or more risk zones. In yet another example, the aerial drone flies during night hours to be less visible to an animal and/or human to operate the drone-disabling instrument.

In another embodiment, based on the probability of encountering the drone-disabling instrument, the routing module 201 or the local component of the aerial drone determines whether to instruct the aerial drone to complete a delivery in the geographic area based on the map data layer. By way of example, when the risk is too high or the risk area is very big (e.g., city riots, terrorist attacks, wars, etc.), the aerial drone may be instructed to cancel the delivery.

In other embodiments, the routing module 201 further considers non-drone-disabling-instrument related risk factors, such as electromagnetic fields, absence of GPS or other location signals, winds or other weather conditions, network (e.g., cellular network) coverage, aviation-related data (e.g., air traffic, etc.), etc. The non-drone-disabling-instrument related risk factors can be considered independent from drone-disabling instruments to determine a map data layer of a geographic database on their own.

In one embodiment, the routing module 201 receives map data indicating a spatial concentration data of one or more risk factors over a geographic area, generates a route over the geographic area with one or more attitude changes based on the spatial concentration, and configures an aerial drone to fly the route. The route can be generated by minimizing a probability of the aerial drone 101 encountering the one or more risk factors. By way of example, the one or more risk factors include crime data, flying animal data, ground animal data, human population sector data, or a combination thereof.

In another embodiment, the routing module 201 calculates a probability of encountering the one or more risk factors based on the map data, and initiates an activation of at least one sensor of the aerial drone 101. The at least one sensor is configured to collect sensor data for determining a presence of the one or more risk factors. In yet another embodiment, the routing module 201 uses the sensor data to update the map data indicating the spatial concentration of the one or more risk factors, such as one or more lidar sensors detecting actors of the risk factors (e.g., flying animals), etc. By way of example, the routing module 201 can retrieve information of the actors of the risk factors, such as their habitats and behavior patterns, etc., to determine damage impacts, avoiding strategies, etc.

In yet another embodiment, the routing module 201 calculates a probability of encountering the one or more risk factors based on the map data, and initiates an evasive maneuver by the aerial drone 101 based on determining that probability is greater than a threshold probability. By way of example, the aerial drone 101 flies above, around, or below the one or more risk zones in the data model. In another example, the aerial drone 101 flies via the one or more risk zones faster than a threshold reachable by the one or more risk factors. In yet another example, the aerial drone flies via the one or more risk zones in a pattern, in or near a shelter, or a combination thereof, to dodge the one or more risk factors mapped in the one or more risk zones. In yet another example, the aerial drone flies during night hours to be less visible to an animal and/or human representing the one or more risk factors.

In one embodiment, electromagnetic field data can be sensed used using sensors located on aerial vehicles 101, in the infrastructure (e.g., smart city infrastructure), and/or from any other sensor in the area of interest. In addition or alternatively, historical or previously sensed electromagnetic data that has been stored for the areas of interest along the flight path can be stored and retrieved from the geographic database 121. Data on the absence of GPS or other location signals in the areas of interest can also be sensed or retrieved from the geographic database 121. Areas with no or low GPS reception or equivalent (e.g., areas with high multi-path signal interference) can cause the aerial vehicle 101 to have inaccurate positioning information. Weather data (e.g., winds or other weather conditions) can retrieved from weather services or applications provided by the services platform 111 and/or any of the services 113a-113n. Wind or weather conditions that exceed the operational capability of the aerial vehicle 101 can cause the aerial vehicle 101 to be more susceptible to being blown off course or into other objects, or from weather related damage (e.g., lightning strikes, hail damage, snow, etc.). Network coverage data can be retrieved from the communication network 109, services platform 111, and/or services 113a-113n. Network coverage data can include cellular or other data network signal strength or availability. Losing communications connections between the aerial vehicle 101 and a corresponding remote pilot, remote operator, or remote data service can increase safety risks. Finally, aviation-related data such as air traffic, flight restrictions, etc. can be retrieved from the services platform 111, services 113a-113n, and/or geographic database 121. By way of example, increased air traffic in the geographic can increase safety risks of colliding with other aerial vehicles.

It is noted that the above risk factors are provided by way of illustration and not as limitations. It is contemplated that data on any other location-based risk factor that can affect the safety of aerial flight over an area of interest can be sensed/retrieved and incorporated into the risk data layer and/or the risk data model according to the described embodiments.

Visualization or rendering of the risk data layer could be offered on a plurality of user interfaces for various purposes including but not limited to: (1) an application for trip planning (e.g., on a desktop computer or device); (2) an augmented reality (AR) view for live visualization by the pilot, co-pilot, and/or any other user; (3) an on-device dashboard interface; (4) an autonomous system use (e.g., for a pilot/controller of the aerial vehicle 101, other data post processing uses, etc.); and/or the like.

In one embodiment, as described above, the calculated risk levels for the areas of interest can be time sensitive. In other words, the level of risk can be a function of time by updating the risk-related data collected from the areas of interest in real-time, continuously, periodically, according to a schedule, or a combination thereof. The updated risk-related data or risk factors can then be used to update the risk data layer and/or the risk data model associated with the flight path. In this way, the visualization module 207 can dynamically adjust at least one dimension (e.g., height) of the risk data layer/model as function of time.

The embodiments of visualizing risk levels or aerial vehicle flights described herein provide for several advantages. For example, quickly presenting or displaying risks makes aerial flights safer. The unique visualization also is more convenient and efficient for pilots/controllers to plan flying journeys. The intuitive presentation also enables faster reaction time for pilots/controllers who need to react to changing conditions during a flight. As another advantage, the embodiments of risk data layers/models which is often invisible to the naked eye.

Although the various embodiments are discussed with respect to aerial flights, it is contemplated that the embodiments for visualizing risk levels can be used for other applications such as but not limited to off-road travel, optimizing traffic flows, determining insurance coverage, and/or any other application where aggregated risks are to be visualized.

The geographic area can include any location or area for which a dynamic drone-disabling instrument density is to be predicted. The area can be specified as a point location with a surround radius, as a bounded area, etc. The area of interest can also be specified as a point of interest (e.g., a building, structure, park, etc.) or geopolitical boundary (e.g., neighborhood, city, state, region, country, etc.). In one embodiment, the data ingestion module 203 retrieves or otherwise determines event data for the location. The event data includes any data that can be sensed, reported, recorded, stored, etc. that is associated with or indicative of any events attracting drone-disabling instruments within the area of interest. The data ingestion module 203 can determine the event data from any of a plurality of data sources. These data sources can be provided, for instance, by the services platform 111, services 113a-113n (also collectively referred to as services 113), content providers 115a-115m (also collectively referred to as content providers 115), and/or equivalent platforms. By way of example, the plurality of data sources can include but is not limited to any combination or subset of:
Online event data, such as Social media event data
Positioning data from a mobile device in events (e.g., UE 107);
Traffic data near events; and
Public transport routing request data for the events.

In one embodiment, input features can be extracted from the event data to support dynamic drone-disabling instruments density prediction according to the embodiments described herein and then processed using the machine learning model 211.

In one embodiment, the prediction of the drone-disabling instrument density is generated based on a trained machine learning model 211. The trained machine learning model 211, for instance, is trained using ground truth data correlating reference historical event data to ground truth drone-disabling instrument density data. Accordingly, in one embodiment, the data ingestion module 203 can acquire ground truth data from one or more locations that are similar to expected areas of interest. The ground truth data, for instance, correlates reference historical drone-disabling instrument density data to ground truth drone-disabling instrument density data. Reference historical drone-disabling instrument density data includes one or more input data sources with known values or parameters. The set of known drone-disabling instrument density data values can be referred to as ground truth input feature sets. These feature sets can then be labeled with ground truth drone-disabling instrument density data that reflects known drone-disabling instrument density data or drone-disabling instrument density data that has been accepted or otherwise treated as the true drone-disabling instrument density of an area exhibiting the reference event data values.

As discussed above, the machine learning model 211 uses training or ground truth data to automatically “learn” or detect relationships between different input feature sets and then output a predicted drone-disabling instrument density based on those feature sets. In one embodiment, at least one of the input features or values includes a temporal parameter that indicates the times at which the ground input feature sets and corresponding ground truth drone-disabling instrument densities was collected or determined. In this way, the trained machine learning model 211 can include time as a dynamic parameter so that the machine learning model 211 can learn the relationship between drone-disabling instrument density and time. For example, the dynamic parameter can provide for the prediction of the drone-disabling instrument density with respect to a time of day, a day, a week, a season, a year, or a combination thereof.

In one embodiment, the machine learning model 211 can be trained using the acquired ground truth training data set. For example, the mapping platform 117 can incorporate a supervised learning model (e.g., a logistic regression model, Random Forest model, and/or any equivalent model) to provide feature matching probabilities that are learned from the training data set. For example, during training, the prediction module 209 uses a learner module that feeds input feature sets from the ground truth training data set into the machine learning model 211 to compute a predicted drone-disabling instrument density using an initial set of model parameters. The learner module then compares the predicted matching probability of the predicted drone-disabling instrument density feature to the ground truth drone-disabling instrument density data for each input feature set in the ground truth training data set. The learner module then computes an accuracy of the predictions for the initial set of model parameters. The prediction of the drone-disabling instrument density can then be further based on the relative weighting information among the input features to train the machine learning model 211.

To use the trained machine learning model 211 to make predictions, the prediction module 209 selects or receives an input for selecting a time for which the dynamic drone-disabling instrument density prediction is to be made. The selected time can be any time in the future or the past. For example, in an aerial vehicle 101 use case, a future time can be selected to correspond to when the aerial vehicle 101 is expected to arrive or fly over the selected area of interest to assist in assessing the safety risk associated with a geographic area.

In one embodiment, after generating the dynamic population density data or prediction, the output module 213 can generate a visual representation of the drone-disabling instrument density. Examples of such a visual representation is shown in FIGS. 4A-4C.

Returning to FIG. 1, as shown, the system 100 comprises an aerial vehicle 101 equipped with a variety of sensors that is capable operating in airspaces overpopulated or unpopulated areas. In one embodiment, the aerial vehicle 101 can fly or otherwise operate autonomously or under direct control via the UE 107 that may include or be associated with one or more software applications 119 supporting routing based on risk level predictions and/or visualizations according to the embodiments described herein. As previously discussed, the system 100 further includes mapping platform 117 coupled to the geographic database 121, wherein the mapping platform 117 performs the functions associated with visualizing risk levels, providing dynamic population density prediction, and/or aerial vehicle routing as discussed with respect to the various embodiments described herein. In one embodiment, the aerial vehicle 101, mapping platform 117, UE 107, and other components of the system 100 have connectivity to each other via the communication network 109.

In one embodiment, the aerial vehicle 101 is capable of operating autonomously or via a remote pilot using UE 107 to fly the aerial vehicle 101 or configure a flight path or route for the aerial vehicle 101. In one embodiment, the aerial vehicle 101 is configured to travel using one or more modes of operation over population or unpopulated areas. The aerial vehicle 101 many include any number of sensors including cameras, recording devices, communication devices, etc. By way example, the sensors may include, but are not limited to, a global positioning system (GPS) sensor for gathering location data based on signals from a positioning satellite, Light Detection And Ranging (LIDAR) for gathering distance data and/or generating depth maps, a network detection sensor for detecting wireless signals or receivers for different short-range communications (e.g., Bluetooth®, Wireless Fidelity (Wi-Fi), Li-Fi, Near Field Communication (NFC), etc.), temporal information sensors, a camera/imaging sensor for gathering image data, and the like. The aerial vehicle 101 may also include recording devices for recording, storing, and/or streaming sensor and/or other telemetry data to the UE 107 and/or the mapping platform 117 for mapping or routing.

In one embodiment, the aerial vehicle 101 is capable of being configured with and executing at least one route based on visualized risk levels, dynamic population density predictions according to the embodiments described herein. The aerial vehicle 101 can also be configured avoid areas with high risk levels, populated areas, objects, and/or obstructions. In addition, the aerial vehicle 101 can be configured to observe restricted paths or routes. For example, the restricted paths may be based on governmental regulations that govern/restrict the path that the aerial vehicle 101 may fly (e.g., Federal Aviation Administration (FAA) policies regarding required distances between objects). In one embodiment, the system 100 may also take into account one or more pertinent environmental or weather conditions (e.g., rain, water levels, sheer winds, etc. in and around underground passageways and their entry/exit points) in determining a route or flight path.

In one embodiment, the aerial vehicle 101 may determine contextual information such as wind and weather conditions in route that may affect the aerial vehicle 101's ability to follow the specified route and then relay this information in substantially real-time to the system 100. In one embodiment, the aerial vehicle 101 may request one or more modifications of the flight path based, at least in part, on the determination of the contextual information or a change in the real-time calculated risk levels over areas of interest (e.g., newly detected or updated risk factors causing a sudden and unexpected change in risk levels). In one embodiment, the system 100 creates a data object to represent the aerial route and may automatically modify the route data object based on receipt of the contextual information from the aerial vehicle 101 or another source and then transmit the new route object to the aerial vehicle 101 for execution. In one embodiment, the aerial vehicle 101 can determine or access the new route data object and/or determine or access just the relevant portions and adjust its current path accordingly. For example, if multiple highly dense population areas (e.g., buildings) are encountered, the system 100 may condense the width of the aerial vehicle 101's flight path to better ensure that the aerial vehicle 101 will avoid the closely situation population-dense areas.

By way of example, a UE 107 is any type of dedicated aerial vehicle control unit, mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 107 can support any type of interface to the user (such as “wearable” circuitry, etc.). In one embodiment, a UE 107 may support any type of interface for piloting or routing the aerial vehicle 101. In addition, a UE 107 may facilitate various input means for receiving and generating information, including, but not restricted to, a touch screen capability, a keyboard and keypad data entry, a voice-based input mechanism, and the like. Any known and future implementations of a UE 107 may also be applicable.

By way of example, the UE 107 and/or the aerial vehicle 101 may execute applications 119, which may include various applications such as a risk visualization application, an aerial routing application, a location-based service application, a navigation application, a content provisioning application, a camera/imaging application, a media player application, an e-commerce application, a social networking application, and/or the like. In one embodiment, the applications 119 may include one or more feature applications used for visualizing risk levels according to the embodiments described herein. In one embodiment, the application 119 may act as a client for the mapping platform 117 and perform one or more functions of the mapping platform 117. In one embodiment, an application 119 may be considered as a Graphical User Interface (GUI) that can enable a user to configure a route or flight path for execution by aerial vehicle 101 according to the embodiments described herein.

In one embodiment, the communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the mapping platform 117 can interact with the services platform 111 to receive data (e.g., human activity data from a plurality of data sources.) for providing routing or operation of the aerial vehicle 101 based on dynamic population density predictions. By way of example, the services platform 111 may include one or more services 113 for providing content (e.g., human activity data, ground truth data, etc.), provisioning services, application services, storage services, mapping services, navigation services, contextual information determination services, location-based services, information-based services (e.g., weather), etc. By way of example, the services 113 may provide or store non-drone traffic schedule data (e.g., train/subway schedules, etc.), weather data, water level schedules, and/or other data used by the embodiments describe herein. In one embodiment, the services platform 111 may interact with the aerial vehicle 101, UE 107, and/or mapping platform 117 to supplement or aid in providing dynamic population density predictions.

By way of example, the aerial vehicle 101, UE 107, mapping platform 117, and the services platform 111 communicate with each other and other components of the system 100 using well known, new or still developing protocols. In this context, a protocol includes a set of rules defining how the network nodes within the system 100 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

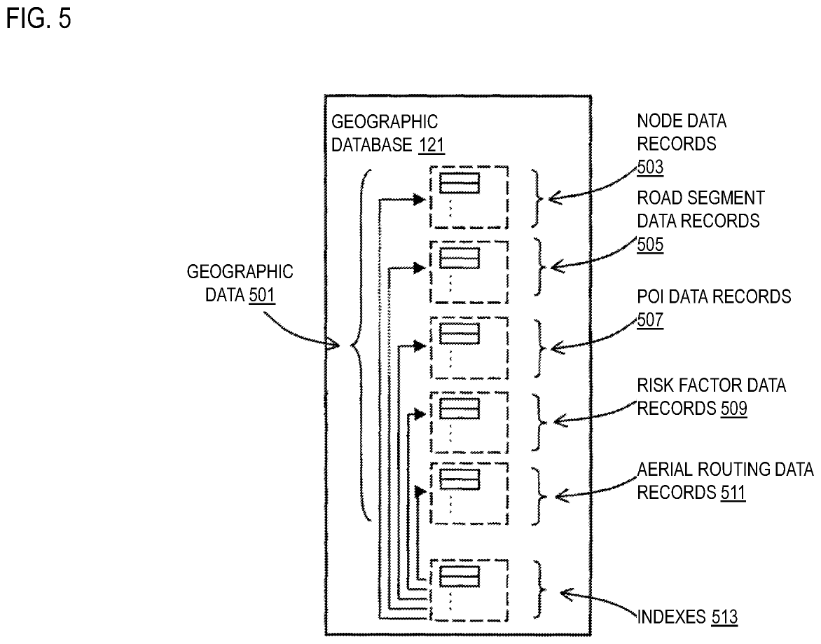

FIG. 5 is a diagram of a geographic database 121 capable of storing map data for dynamic drone-disabling instrument density predictions, according to one embodiment. In one embodiment, the geographic database 121 includes geographic data 501 used for (or configured to be compiled to be used for) mapping and/or navigation-related services, such as for routing aerial vehicles based on drone-disabling instrument density data to create a 3D flightpath or route.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 501 of the database 121 includes node data records 503, road segment or link data records 505, POI data records 507, risk factor data records 509, aerial routing data records 511, and indexes 513, for example. More, fewer or different data records can be provided. In one embodiment, additional data records (not shown) can include cartographic (“carto”) data records, routing data, and maneuver data. In one embodiment, the indexes 513 may improve the speed of data retrieval operations in the geographic database 121. In one embodiment, the indexes 513 may be used to quickly locate data without having to search every row in the geographic database 121 every time it is accessed. For example, in one embodiment, the indexes 513 can be a spatial index of the polygon points associated with stored feature polygons.

In exemplary embodiments, the road segment data records 505 are links or segments representing roads, streets, or paths, as can be used in the calculated route or recorded route information for determination of one or more personalized routes. The node data records 503 are end points corresponding to the respective links or segments of the road segment data records 505. The road link data records 505 and the node data records 503 represent a road network, such as used by vehicles, cars, and/or other entities. In addition, the geographic database 121 can contain path segment and node data records or other data that represent 3D paths around 3D map features (e.g., terrain features, buildings, other structures, etc.) that occur above street level, such as when routing or representing flightpaths of aerial vehicles (e.g., drones 101), for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 507. The geographic database 121 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 121 can also include risk factor data records 509 for the digital map data representing risk factors or risk-related data, calculated risk levels, risk level visualizations, dynamic drone-disabling instrument density predictions generated for areas or interest, and related data. In one embodiment, the risk factor data records 509 can be associated with one or more of the node records 503, road segment records 505, and/or POI data records 507 so that the predicted population densities can inherit characteristics, properties, metadata, etc. of the associated records (e.g., location, address, POI type, etc.). In one embodiment, the system 100 (e.g., via the mapping platform 117 can use the dynamic drone-disabling instrument density predictions to generate aerial vehicles routes.

In one embodiment, the system 100 is capable of generating aerial routes using the digital map data and/or real-time data stored in the geographic database 121 based on risk level visualization and/or predictions. The resulting aerial routing and guidance can be stored in the aerial routing data records 511. By way of example, the routes stored in the data records 511 can be created for individual 3D flightpaths or routes as they are requested by drones or their operators. In this way, previously generated aerial routes can be reused for future drone travel to the same target location.

In one embodiment, the aerial routes stored in the aerial routing data records 511 can be specific to characteristics of the aerial vehicle 101 (e.g., drone type, size, supported modes of operation) and/or other drone-disabling instrument density characteristics of the route. In addition, the aerial routes generated according to the embodiments described herein can be based on contextual parameters (e.g., time-of-day, day-of-week, season, etc.) that can be used to different dynamic drone-disabling instrument density predictions according to the embodiments described herein.

In one embodiment, the geographic database 121 can be maintained by the services platform 111, any of the services 113 of the services platform 111, and/or the mapping platform 117). The map developer can collect geographic data to generate and enhance the geographic database 121. There can be different ways used by the map developer to collect data. These ways can include obtaining data from other sources, such as municipalities or respective geographic authorities. In addition, the map developer can employ aerial drones (e.g., using the embodiments of the privacy-routing process described herein) or field vehicles (e.g., mapping drones or vehicles equipped with mapping sensor arrays, e.g., LiDAR) to travel along roads and/or within buildings/structures throughout the geographic region to observe features and/or record information about them, for example. Also, remote sensing, such as aerial or satellite photography or other sensor data, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle, such as by the aerial vehicle 101, for example. The navigation-related functions can correspond to 3D flightpath or navigation, 3D route planning for package delivery, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for mapping drone-disabling instruments and generating aerial routes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

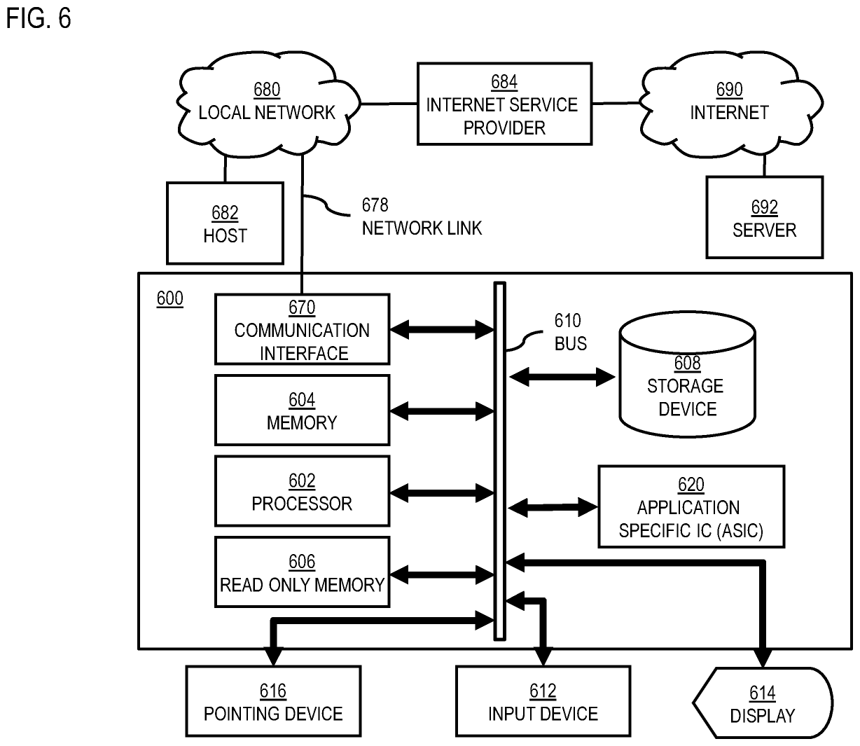

FIG. 6 illustrates a computer system 600 upon which an embodiment of the invention may be implemented. Computer system 600 is programmed (e.g., via computer program code or instructions) to map drone-disabling instruments and generate aerial routes as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to mapping drone-disabling instruments and generating aerial routes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for mapping drone-disabling instruments and generating aerial routes. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for mapping drone-disabling instruments and generating aerial routes, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for mapping drone-disabling instruments and generating aerial routes to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system can be deployed in various configurations within other computer systems, e.g., host 682 and server 692.

FIG. 7 illustrates a chip set 700 upon which an embodiment of the invention may be implemented. Chip set 700 is programmed to map drone-disabling instruments and generate aerial routes as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to map drone-disabling instruments and generate aerial routes. The memory 705 also stores the data associated with or generated by the execution of the inventive steps.

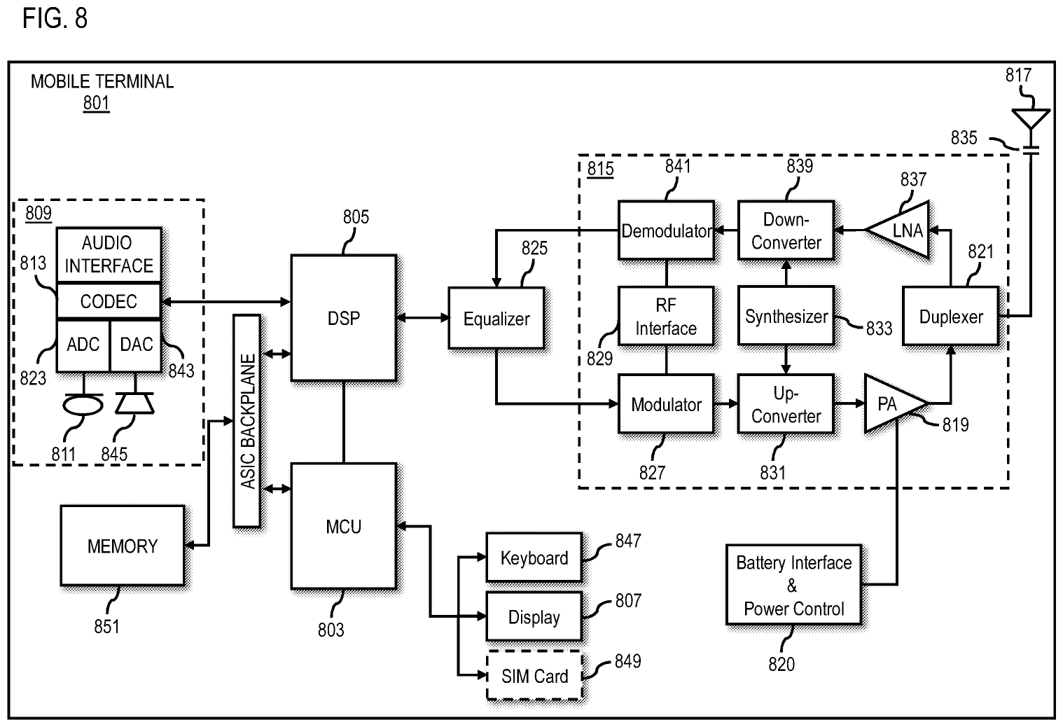

FIG. 8 is a diagram of exemplary components of a mobile terminal 801 (e.g., handset or vehicle/aerial vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to map drone-disabling instruments and generate aerial routes. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 851 may be, but not limited to, a single memory, CD, DVD, ROM, RAM, EEPROM, optical storage, or any other non-volatile or non-transitory storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving map data indicating a spatial concentration of a drone-disabling instrument over a geographic area;
generating a map data layer of a geographic database based on the spatial concentration; and
providing the map data layer as an output.

2. The method of claim 1, further comprising:
retrieving real-time data, historical data, or a combination thereof indicating the spatial concentration of the drone-disabling instrument,
wherein the spatial concentration is based on the real-time data, the historical data, or a combination thereof.

3. The method of claim 1, further comprising:
routing an aerial drone over the geographic area based on the map data layer; and
creating a data model representing an effective range of the drone-disabling instrument,
wherein the map data layer further includes the data model.

4. The method of claim 3, wherein the routing of the aerial drone comprises:
determining a route over the geographic area based on the data model representing the effective range of the drone-disabling instrument in combination with terrain data for the geographic area.

5. The method of claim 4, wherein the spatial concentration includes real-time spatial concentration data, and wherein the routing comprises calculating a real-time routing instruction based on the real-time spatial concentration data.

6. The method of claim 5, wherein the real-time routing instruction is calculated by a local component of the aerial drone for real-time use by the aerial drone.

7. The method of claim 4, wherein the route is calculated using a cost function based on minimizing a probability of the aerial drone encountering the drone-disabling instrument over the geographic area.

8. The method of claim 3, wherein the data model further indicates a predicted damage level to the aerial drone, a payload of the drone, or a combination thereof that is calculated to be inflicted by the drone-disabling instrument, and wherein the routing is further based on the predicted damage level.

9. The method of claim 3, wherein the aerial drone is a delivery drone, and wherein the drone-disabling instrument is configured to intercept the delivery drone, a payload of the delivery drone, or a combination thereof.

10. The method of claim 3, further comprising:
determining whether to instruct the aerial drone to complete a delivery in the geographic area based on the map data layer.

11. The method of claim 1, wherein the spatial concentration is determined based on at least one of:
ownership data indicating a number of owners of the drone-disabling instrument in the geographic area;
crime data indicating a number of crimes committed using the drone-disabling instrument in the geographic area;
sales data indicating a number of sales of the drone-disabling instrument in the geographic area; and
event data indicating a presence of or a number of events in which the drone-disabling instrument is used in the geographic area.

12. An apparatus comprising:
at least one processor; and
at least one memory including computer program code for one or more programs,
the at least one memory and the computer program code configured to, with the at least one processor, cause the apparatus to:
receive map data indicating a spatial concentration data of one or more risk factors over a geographic area;
generate a route over the geographic area with one or more attitude changes based on the spatial concentration; and
configure an aerial drone to fly the route.

13. The apparatus of the claim 12, wherein the route is generated by minimizing a probability of the aerial drone encountering the one or more risk factors, and wherein the one or more risk factors include crime data, flying animal data, ground animal data, human population sector data, or a combination thereof.

14. The apparatus of claim 13, wherein the apparatus is further caused to:
calculating a probability of encountering the one or more risk factors based on the map data; and
initiating an activation of at least one sensor of the aerial drone,
wherein the at least one sensor is configured to collect sensor data for determining a presence of the one or more risk factors.

15. The apparatus of claim 14, wherein the sensor data is used to update the map data indicating the spatial concentration of the one or more risk factors.

16. The apparatus of claim 12, wherein the apparatus is further caused to:
calculate a probability of encountering the one or more risk factors based on the map data; and
initiate an evasive maneuver by the aerial drone based on determining that probability is greater than a threshold probability.

17. A non-transitory computer-readable storage medium carrying one or more sequences of one or more instructions which, when executed by one or more processors, cause an apparatus to perform:
determining a spatial concentration of a vehicle-disabling instrument in a geographic area;
generating a map data layer based on the spatial concentration; and
providing the map data layer as an output,
wherein the output is published in a geographic database.

18. The non-transitory computer-readable storage medium of claim 17, wherein the apparatus is caused to further perform:
retrieving real-time data, historical data, or a combination thereof indicating the spatial concentration of the vehicle-disabling instrument,
wherein the spatial concentration is based on the real-time data, the historical data, or a combination thereof.

19. The non-transitory computer-readable storage medium of claim 17, wherein the apparatus is caused to further perform:
creating a data model representing an effective range of the vehicle-disabling instrument,
wherein the map data layer further includes the data model.

20. The non-transitory computer-readable storage medium of claim 19, wherein the apparatus is caused to further perform:
determining a route based on the data model representing the effective range of the vehicle-disabling instrument in combination with terrain data.
